(19) United States
(12) Patent Application Publication
(10) Pub. No.: US 2015/0059663 A1
(43) Pub. Date: Mar. 5, 2015

(54) COOLING SYSTEM FOR MACHINE SYSTEM

(71) Applicant: Perkins Engines Company Limited, Peterborough (GB)

(72) Inventors: Antonis DRIS, Godmanchester (GB); Paul R. MOORE, Peterborough (GB)

(73) Assignee: Perkins Engines Company Limited, Peterborough (GB)

(21) Appl. No.: 14/535,355

(22) Filed: Nov. 7, 2014

(51) Int. Cl. F01P 9/04; F02B 63/04

(52) U.S. Cl. CPC F01P 9/04; F02B 63/04
USPC 123/2

(57) ABSTRACT

A cooling system for a machine system is disclosed herein. The machine system includes an internal combustion engine, a plurality of heat generating systems, an energy recovery system, and a cooling system. The energy recovery system is adapted to produce an electrical output and includes a condenser to condense a working fluid that circulates within the machine. The cooling system includes a plurality of fans, a condenser fan, and a control unit. The plurality of fans and the condenser fan are powered by the electrical output. The fans are adapted to cool the heat generating systems. The condenser fan is adapted to cool the condenser. The control unit is adapted to selectively control each of the plurality of fans, based on load requirements of the corresponding heat generating system. Therefore, the control unit optimizes and maximizes heat transfer by the condenser fan to the working fluid.

### TECHNICAL FIELD

The present disclosure relates generally to a machine system. More specifically, the present disclosure relates to a cooling system for the machine system.

### BACKGROUND

Internal combustion engines are commonly known to generate power required to run a machine. Exhaust gases from an internal combustion engine may have a high temperature. Typically, the exhaust gases are released into the environment, resulting in a significant waste of thermal energy. Therefore, the internal combustion engine may sometimes be provided with an energy recovery system to recover energy of exhaust gases.

The energy recovery system is known to recover energy from the exhaust gases and produce an electrical output. The energy recovery system commonly includes a condenser that requires to be cooled, for efficient production of electrical output.

A cooling system is installed to cool the condenser and is powered by the electrical output from the energy recovery system. Conventional cooling systems may include a single fan to cool the condenser as well as a multiplicity of heat generating systems, such as an engine radiator, a transmission and a hydraulic system. Since a single fan is used to cool the condenser and the multiplicity of heat generating systems, the fan may be inefficient to cool the condenser. In addition, a large and/or bulky fan may be required to fulfill the cooling demands of the condenser. This large and/or bulky cooling fan may require a high amount of power for operation, which may not be accomplished by the energy recovery system alone. This may result in poor cooling of the condenser.

### SUMMARY OF THE INVENTION

Various aspects of the present disclosure are directed to a machine system to run a machine. The machine system includes an internal combustion engine, a plurality of heat generating systems, an energy recovery system, and a cooling system. The energy recovery system is in communication with the internal combustion engine. The energy recovery system is adapted to extract heat from exhaust gases associated with the internal combustion engine to produce an electrical output. The energy recovery system includes a condenser to condense a working fluid that circulates within the energy recovery system. The cooling system is integrated with the energy recovery system and includes a plurality of fans, a condenser fan, and a control unit. The plurality of fans is powered by the electrical output produced by the energy recovery system. Each of the plurality of fans is structured and arranged to cool one or more of the plurality of heat generating systems. The condenser fan is powered by the electrical output generated by the energy recovery system and is structured and arranged to cool the condenser. The control unit is adapted to selectively control each of the plurality of fans based on load requirements of the corresponding heat generating system. Thereby the control unit is configured to optimize and maximize heat transfer by the condenser fan to the working fluid.

### BRIEF DESCRIPTION OF THE DRAWINGS

FIG. 1 is a schematic block diagram of a machine system that illustrates an energy recovery system and associated cooling system, in accordance with the concepts of the present disclosure.

### DETAILED DESCRIPTION

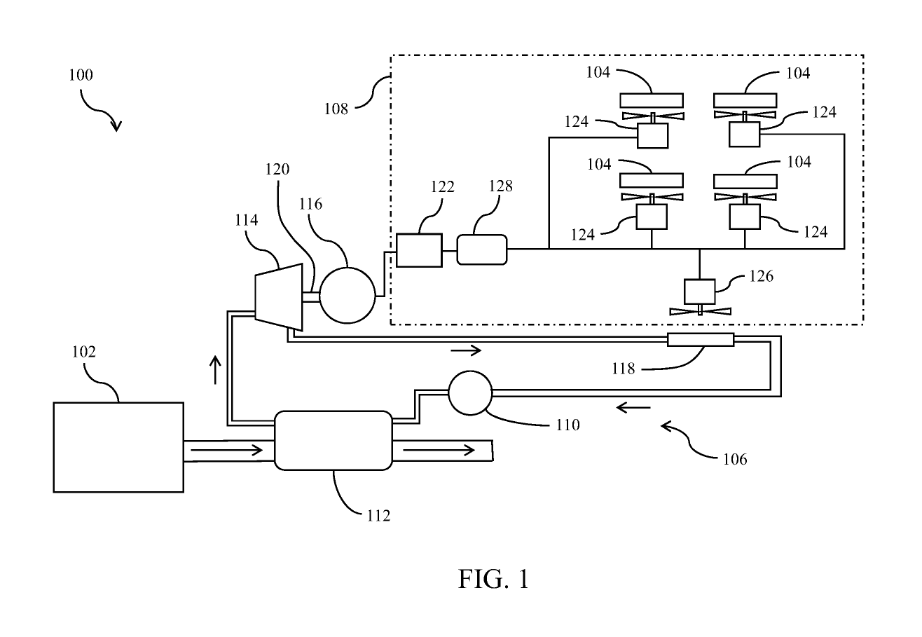

Referring to FIG. 1, there is shown a machine system 100 to run a machine. The machine may embody vehicles, such as but not limited to, a construction machine, an irrigation machine, a forest machine, a marine machine, and/or a stationary power machine. The machine system 100 includes an internal combustion engine (ICE) 102, a plurality of heat generating systems 104, an energy recovery system 106, and a cooling system 108.

The ICE 102 is a power source of the machine system 100 that generates power required to run the machine. The ICE 102 works in conjunction with the plurality of heat generating systems 104 to run the machine efficiently. The plurality of heat generating systems 104 may include a transmission system, a hydraulic system, an air to air charge cooling (ATAC) system, an engine radiator, and or other systems known in the art. Moreover, the ICE 102 produces exhaust gases during power generation in the machine system 100. These exhaust gases may be passed through the energy recovery system 106 to recover heat from the exhaust gases.

The energy recovery system 106 may operate using the principles of an organic rankine cycle. The energy recovery system 106 is arranged so that it is in fluid communication with the ICE 102. The energy recovery system 106 is adapted to receive exhaust gases from the ICE 102 and recover heat from the exhaust gases to produce an electrical output. The energy recovery system 106 includes a fluid pump 110, an evaporator device 112, a turbine 114, an electrical generator 116, and a condenser 118. The fluid pump 110 is adapted to circulate a working fluid through the evaporator device 112, the turbine 114, and the condenser 118 in a closed loop manner.

The evaporator device 112 is in fluid communication with the fluid pump 110 and is disposed downstream of the fluid pump 110. The evaporator device 112 receives the working fluid from the fluid pump 110 and is adapted to heat the received working fluid. In addition, the evaporator device 112 is in fluid communication with the ICE 102 that facilitates the flow of exhaust gases from the ICE 102 to the evaporator device 112. Thereby, the energy recovery system 106 is in fluid communication with the ICE 102. The evaporator device 112 is adapted to transfer thermal energy from exhaust gases to the working fluid that flows within the evaporator device 112.

The turbine 114 is in fluid communication with the evaporator device 112 and is disposed downstream of the evaporator device 112. The heated working fluid from the evaporator device 112 flows to the turbine 114 and rotates the turbine 114. More specifically, the heated working fluid rotates a blade-shaft arrangement (not shown) of the turbine 114 and is cooled. The blade-shaft arrangement (not shown) includes a shaft 120 that extends between the turbine 114 and the electrical generator 116.

The electrical generator 116 is operatively connected to the turbine 114. More particularly, the shaft 120 is connected to the turbine 114 at one end and forms a rotor of the electrical generator 116 at the other end. The electrical generator 116 converts rotational motion of the shaft 120 into electrical output. This electrical output can then be used to run the cooling system 108.

The condenser 118 is in fluid communication with the turbine 114 and is disposed downstream of the turbine 114. The fluid communication facilitates flow of the working fluid from the turbine 114 to the condenser 118. The condenser 118 is adapted to condense the working fluid that flows through the condenser 118, which is then recirculated in the energy recovery system 106.

During normal operation of the machine system 100, the condenser 118 may heat up and require to be cooled down for continuous operation. Similarly, the heat generating systems 104 may heat up during continuous operation of the machine system 100. For example, an engine radiator may heat up during normal operation of the ICE 102. Therefore, the cooling system 108 is installed to cool the condenser 118 and the heat generating systems 104.

The cooling system 108 is integrated with the energy recovery system 106 and is adapted to cool the plurality of heat generating systems 104 and the condenser 118. The cooling system 108 includes an energy storage apparatus 122, a plurality of fans 124, a condenser fan 126, and a control unit 128.

The energy storage apparatus 122 is electrically connected to the electrical generator 116. The energy storage apparatus 122 is adapted to receive the electrical output from the electrical generator 116. The energy storage apparatus 122 is adapted to supply a portion of the electrical output to the plurality of fans 124, the condenser fan 126, and the control unit 128. In addition, the energy storage apparatus 122 is adapted to store extra amount of the electrical output for future use.

The plurality of fans 124 are electrically connected to the energy storage apparatus 122, via the control unit 128. The plurality of fans 124 are installed proximal to the plurality of heat generating systems 104. Each of the plurality of fans 124 is powered by the electrical output from the energy storage apparatus 122 and is adapted to cool one or more of the plurality of heat generating systems 104. In an embodiment, one of the plurality of fans 124 is adapted to cool one of the plurality of heat generating systems 104.

Similar to the plurality of fans 124, the condenser fan 126 is installed proximal to the condenser 118 of the energy recovery system 106. The condenser fan 126 is also powered by the electrical output from the energy storage apparatus 122 and is adapted to cool the condenser 118.

The control unit 128 is installed between the energy storage apparatus 122 and the plurality of fans 124. The control unit 128 may be a combination of electrical components that perform in conjunction to selectively control each of the plurality of fans 124. The control unit 128 includes a plurality of sensors that sense the load requirements of various heat generating systems 104. For example, the control unit 128 may include a thermostat that senses the load requirement of one of the heat generating systems 104, based on the temperature of the heat generating systems 104. The control unit 128 selectively activates and deactivates one or more of the plurality of fans 124, based on the load requirements of the corresponding heat generating system 104. This enables power conservation by the cooling system 108. Hence, the conserved energy may be used for continuous operation of the condenser fan 126. This enables efficient operation of the condenser fan 126. More specifically, the control unit 128 optimizes and maximizes heat transfer by the condenser fan 126 to the working fluid.

### INDUSTRIAL APPLICABILITY

In operation, the energy recovery system 106 circulates the working fluid through the evaporator device 112, the turbine 114, and the condenser 118, in a closed loop manner. More specifically, the fluid pump 110 circulates the working fluid through the evaporator device 112, the turbine 114, and the condenser 118.

The evaporator device 112 receives exhaust gases from the internal combustion engine (ICE) 102 and working fluid from the fluid pump 110. The evaporator device 112 transfers the thermal energy of the exhaust gases to the working fluid flowing through the evaporator device 112. Thus, the working fluid is heated up to its gaseous form. The heated working fluid is then passed through the turbine 114.

The turbine 114 is structured and arranged to convert thermal energy of the heated working fluid to a rotational motion of the shaft 120. The rotational motion of the shaft 120 is then used by the electrical generator 116 to produce the electrical output. Moreover, the working fluid is cooled, while flowing through the turbine 114. The working fluid is then passed through the condenser 118 to be condensed and recirculated.

The cooling system 108 is installed to cool the condenser fan 126 and the plurality of heat generating systems 104. The cooling system 108 consists of a plurality of fans 124. The plurality of fans 124 are powered by the electrical output produced by the electrical generator 116 and are adapted to cool the plurality of heat generating systems 104. For example, the plurality of fans 124 may generate a flow of air through a radiator of the corresponding heat generating systems 104 to cool those heat generating systems 104.

Similarly, the condenser fan 126 is also powered by the electrical output produced by the electrical generator 116 and is adapted to cool the condenser 118. The condenser fan 126 may require a large amount of electrical output to run continuously and enable heat transfer through the condenser 118. Therefore, the control unit 128 is installed to conserve energy from the plurality of fans 124. The conserved energy is then used to run the condenser fan 126.

The control unit 128 selectively controls each of the plurality of fans 124, based on load requirements of the corresponding heat generating system 104. More specifically, the control unit 128 may deactivate one or more of the plurality of fans 124, when load requirement of the corresponding heat generating system 104 exceeds a predetermined value. The cooling process enables energy conservation. The conserved energy may then be used to run the condenser fan 126. Therefore, the control unit 128 optimizes and maximizes heat transfer by the condenser fan 126 to the working fluid that flows in the condenser 118. It may also be noted that the specific arrangement of dedicated fan 124 for each of the plurality of heat generating systems 104 require use of smaller cooling fans as compared to a single, bulky fan to cool the plurality of heat generating systems 104. This improves packaging of the machine system 100. Further, the energy conservation by the control unit 128 enables increased fuel economy of the machine system 100.

It should be understood that the above description is intended for illustrative purposes only and is not intended to limit the scope of the present disclosure in any way. Those skilled in the art will appreciate that other aspects of the disclosure may be obtained from a study of the drawings, the disclosure, and the appended claim.

What is claimed is:

1. A machine system comprising:
an internal combustion engine;
a plurality of heat generating systems;
an energy recovery system in communication with the internal combustion engine, the energy recovery system adapted to extract heat from exhaust gases associated with the internal combustion engine to produce an electrical output, the energy recovery system including:
a condenser for condensing a working fluid circulating within the energy recovery system;
a cooling system integrated with the energy recovery system , the cooling system including:
a plurality of fans powered by the electrical output produced by the energy recovery system, each of the plurality of fans structured and arranged to cool one or more of the plurality of heat generating systems;
a condenser fan powered by the electrical output generated by the energy recovery system, the condenser fan being structured and arranged to cool the condenser; and
a control unit adapted to selectively control each of the plurality of fans based on load requirements of the corresponding heat generating system, thereby the control unit being configured to optimize and maximize heat transfer by the condenser fan to the working fluid.
